(19) United States
(12) Patent Application Publication
(10) Pub. No.: US 2015/0176682 A1
(43) Pub. Date: Jun. 25, 2015

(54) HYBRID DRIVE TRAIN FOR A MOTOR VEHICLE

(71) Applicant: GETRAG Getriebe- und Zahnradfabrik Hermann Hagenmeyer GmbH & Cie KG, Untergruppenbach (DE)

(72) Inventors: Guenter Ruehle, Loechgau (DE); Klaus Sommer, Obersulm (DE); Soeren Wenzel, Schefflenz (DE)

(21) Appl. No.: 14/576,012

(22) Filed: Dec. 18, 2014

(30) Foreign Application Priority Data
Dec. 19, 2013 (DE) 10 2013 022 142.0

(51) Int. Cl. F16H 3/00

(52) U.S. Cl. CPC F16H 3/006; Y10S 903/919

(57) ABSTRACT

Hybrid drive train for a motor vehicle, comprising an internal combustion engine, an electric machine and a dual clutch transmission. The transmission has a dual clutch arrangement and a spur gear transmission arrangement with two part-transmissions. The spur gear transmission arrangement is configured to set exactly three forward gear stages, or is configured to set exactly four forward gear stages. The spur gear transmission arrangement being configured with three parallel shaft arrangements which are connected to one another via gear set arrangements in such a way that motive power is transmitted via at least two of the shaft arrangements, depending on the forward gear stage engaged.

### CROSSREFERENCES TO RELATED APPLICATIONS

This application claims the priority of German patent application DE 10 2013 022 142.0, filed Dec. 19, 2013.

### BACKGROUND

The present invention relates to a hybrid drive train for a motor vehicle, comprising an internal combustion engine, an electric machine and a dual clutch transmission having a dual clutch and a spur gear transmission arrangement with two part-transmissions.

A hybrid drive train of this type is known, for example, from the documents DE 10 2011 110 444 A1 or DE 10 2011 102 267 A1.

In the case of hybrid transmissions a distinction is generally made between those in which motive power is provided primarily by the internal combustion engine and the electric machine is used as an auxiliary unit. Such drive trains usually have a largely conventional layout, both the internal combustion engine and the electric machine being arranged as a rule upstream of an input of a clutch arrangement. Dual clutch transmissions generally in use today, which are used in such hybrid drive trains, have five, six, seven or more forward gear stages and consequently are built comparatively long axially. This represents a very high hurdle, especially when such a drive train is installed in a front-transverse position in a motor vehicle.

A further type of hybrid drive train are the so-called “range extenders”. Here, the primary drive source is generally the electric machine. The internal combustion engine is used only to charge a battery, or in an auxiliary operating mode. The hybrid drive trains known from the two above-mentioned documents relate to such a range extenders. In this type of hybrid drive train, as a rule only one or two forward gear stages are implemented, since an electric machine can start from standstill (0 rpm) and can deliver high torque at standstill, generally making the provision of a large number of gear stages superfluous.

In range extender drive trains the internal combustion engine, in so far as it is also used as a drive source, is generally utilized only at relatively high speeds, so that the selection of one forward gear stage or two forward gear stages seems to represent a sensible compromise. In the case of a hybrid drive train with a dual clutch transmission it is also known to connect an electric machine to the input of one of the two part-transmissions (DE 10 2010 004 711 A1). Also known are hybrid vehicles having dual clutch transmissions in which two further clutches (starting clutch and separating clutch) are arranged between an electric machine and an internal combustion engine. Such a drive train is known, for example, from the document WO 2009/056193 A2.

It is further known to couple the motive power of an electric machine and of an internal combustion engine via a planetary gear arrangement (WO 2010/063735 A1).

Another approach to a hybrid drive consists in providing a transmission having two gear stages which are allocated exclusively to the electric machine, and three forward gear stages which are allocated exclusively to the internal combustion engine (WO 2012/079683 A2).

### SUMMARY

Against this background it is an object of the invention to specify an improved hybrid drive train.

This object is achieved with the hybrid drive train mentioned in the introduction, in that the spur gear transmission arrangement is configured to set exactly three forward gear stages, or is configured to set exactly four forward gear stages, the spur gear transmission arrangement being configured with three parallel shaft arrangements which are connected to one another via gear set arrangements in such a way that motive power is transmitted via at least two of the shaft arrangements, depending on the forward gear stage selected.

The hybrid drive train according to the invention is consequently distinguished by the fact that a mean number of forward gear stages which is larger than two and smaller than the number of forward gear stages achievable with conventional motor vehicle drive trains (for example five, six, seven or more forward gear stages) can be set.

This makes it possible to utilize the internal combustion engine and the electric machine almost equivalently as drive sources. In addition, such a construction makes it possible to connect the internal combustion engine and the electric machine to the input of the dual clutch arrangement. With such a design, only a small amount of axial installation space is available for the transmission, for constructional reasons. A spur gear transmission arrangement having exactly three or exactly four forward gear stages can in this case be built axially short, so that installation of such a hybrid drive train in a motor vehicle is also possible with a front-transverse layout.

The hybrid drive train can be designed as a range extender, in which the electric machine represents the main drive source of the vehicle and the internal combustion engine is utilized only for special driving events (relatively high speeds, long travel distances, etc.). As a result of the preferred measure of connecting, or making connectable, the internal combustion engine and the electric machine to the input of the dual clutch arrangement, it is possible to make all the forward gear stages of the spur gear transmission arrangement available to both types of drive motor for torque and speed conversion. As a result of the configuration of the spur gear transmission with two part-transmissions and an associated dual clutch, gear stage changes can be executed under load and without interrupting the traction force.

Furthermore, through the relatively wide ratio spread of a spur gear transmission arrangement implemented in this way, the internal combustion engine can also be utilized for starting and for low driving speeds.

In the case of both alternatives (three and four forward gear stages), it is possible to design the spur gear drive arrangement without or with a reverse gear stage. If the spur gear transmission arrangement does not have a reverse gear stage, reverse driving operation is possible only by means of the electric machine, which is then driven in the inverse direction for this purpose.

As an overall consequence, it is possible to make the range of the vehicle dependent not only on the battery capacity. Preferably, it is further possible that a separate charging generator used solely to charge a battery of the motor vehicle does not need to be provided. In addition, weight can be saved thereby.

The actuation of the dual clutch arrangement may be effected, for example, by pump actuators, one pump, driven in each case via its own electric motor, being allocated to each clutch of the dual clutch arrangement. In this case an output of the pump is preferably connected directly to an actuator for actuating the respective clutch, that is, without the interposition of proportional valves. The gear stages of the spur gear transmission arrangement are preferably engaged and disengaged by means of shift drums, one or two shift drums being used for this purpose. The shift drums may be driven electromotively (by means of respective associated electric motors).

In general, the measure of designing the spur gear transmission arrangement with three parallel shaft arrangements also makes it possible to achieve an axially short construction of the spur gear transmission arrangement.

The object is therefore achieved in its entirety.

According to an especially preferred embodiment, the internal combustion engine is connected via a coupling device to an input element of the dual clutch arrangement. The coupling device may be a non-positive or positive shiftable clutch. Optionally, the coupling device may also be actuated by means of a pump actuator. In some cases the coupling device may also be implemented by means of a free-wheel.

In this case the electric machine is preferably also connected to the input element of the dual clutch arrangement. In this case it is possible to implement an electromotive operation of the dual clutch transmission without having to sustain the drag of the internal combustion engine.

In general, it is also possible to connect the electric machine to the input element of the dual clutch arrangement via a further coupling device. It is, however, preferred if the electric machine is connected to the input element of the dual clutch arrangement via a permanent rotary coupling. In this case, with propulsion by the internal combustion engine alone, the electric machine is entrained, so that it can work, for example, as a generator, or is operated in idling mode, so that the drag losses are negligible.

According to a further preferred embodiment, at least one respective shift clutch for engaging and disengaging a respective forward gear stage is arranged on two of the shaft arrangements, the shift clutches being aligned axially with one another.

Axial alignment means here that the shift clutches are located substantially in a plane which is oriented transversely to the longitudinal extension of the shaft arrangements, in particular perpendicularly thereto.

Further axial installation space can be saved by this measure.

According to a further preferred embodiment, which in conjunction with the preamble of Claim 1 represents an invention in its own right, the electric machine is connected to an input element of the dual clutch arrangement, the spur gear transmission arrangement having an input shaft arrangement comprising a first input shaft of the first part-transmission and a second, coaxial input shaft of the second part-transmission, together with a first output shaft and a second output shaft, the output shafts each being connected to a respective output gear and the output gears meshing with a drive gear of a differential.

Such a configuration is especially suitable for installation of the drive train in a front-transverse position in a motor vehicle with front-wheel drive.

It is especially advantageous in this case if the internal combustion engine is arranged coaxially with the input shaft arrangement, the electric machine being connected via a spur gear set or by an inverted-tooth chain to the input element of the dual clutch arrangement.

A suitable gear ratio can then be set via the spur gear set, so that the electric machine can be operated at relatively high revolutions in drive mode and can therefore be built relatively compact.

According to a further preferred embodiment, the output gears and the drive gear of the differential form a drive gear set which is arranged between the dual clutch arrangement and gear set arrangements of the forward gear stages in the axial direction.

Through this measure a connection to the differential can be effected, viewed in the axial direction, between the dual clutch arrangement and the internal combustion engine on the one hand and the spur gear transmission arrangement on the other, so that good utilization of installation space can be achieved, especially with front-transverse installation in a motor vehicle.

It is further advantageous if the first input shaft and the first output shaft are connected to one another via two gear sets which are allocated to a first and a third forward gear stage.

This embodiment may be present both with a spur gear transmission arrangement having three forward gear stages and with a spur gear transmission arrangement having four forward gear stages.

Here, the gear sets may each have loose gears which are connectable to the associated shaft via associated shift clutches.

In one embodiment it is preferred that the gear set allocated to the first forward gear stage has a loose gear mounted on the first output shaft via a free-wheel.

Through this measure one shift clutch can be saved, which can also contribute to an axially compact construction.

According to a further preferred embodiment, the second input shaft and the second output shaft are connected to one another via at least one gear set which is allocated to a second forward gear stage.

In this case the second input shaft and the second output shaft may be further connected to one another via a further gear set which is allocated to a fourth forward gear stage, if four forward gear stages are to be implemented.

If the spur gear transmission arrangement is to set exactly three forward gear stages, the part-transmission allocated to the second forward gear stage contains only this one forward gear stage.

In this case it is preferred if this one part-transmission has only one gear stage (for example, the second forward gear stage), which is formed by a gear set with two meshing fixed gears.

In other words, in a spur gear transmission arrangement with three forward gear stages in which only the second forward gear stage is allocated to the one part-transmission, any kind of shift clutch can be dispensed with in this part-transmission, which also contributes to an axially compact construction.

According to a further preferred embodiment, which in conjunction with the preamble of Claim 1 represents an invention in its own right, the spur gear transmission arrangement contains two parallel input shafts and one output shaft, a first friction clutch of the dual clutch transmission arrangement being arranged coaxially with the first input shaft, a second friction clutch of the dual clutch transmission arrangement being arranged coaxially with the second input shaft, and input elements of the friction clutches being connected to a crankshaft of the internal combustion engine via a power-splitting gear set.

With this variant of a hybrid drive train, exactly four forward gear stages can be implemented relatively easily, specifically with only two gear sets and one shift clutch plane, while achieving an axially compact construction.

The power-splitting gear set may be implemented by meshing gear wheels or by a chain wheel set.

With this embodiment it is especially advantageous if the two input shafts and the output shaft are connected to one another via at least one gear set comprising a fixed gear connected non-rotatably to the output shaft, a loose gear mounted rotatably on the first input shaft and a loose gear mounted rotatably on the second input shaft.

Using such a gear set two gear stages can be implemented, one of which is allocated to the one part-transmission and the other to the other part-transmission.

All the forward gear stages of such a transmission are preferably implemented using such a gear set.

With this embodiment it is also advantageous if the electric machine is connected to one of the input shafts.

In contrast to the first-mentioned concept of a hybrid drive train, in which both the internal combustion engine and the electric machine are preferably connected to an input element of the dual clutch arrangement, in the present variant it is preferred if the electric machine is connected to one of the input shafts.

In this case the electric machine may be arranged coaxially with that input shaft, or may be connected to that input shaft via a spur gear set.

In this case it is possible to implement a purely electromotive operating mode via the forward gear stages which are set between this input shaft and the output shaft, preferably the gear stages 1, 3 or the gear stages 2, 4.

It is further advantageous with this variant if the output shaft is connected to an output gear which meshes with a drive gear of a differential.

With this variant, too, the hybrid drive train is preferably suited to front-transverse installation in a motor vehicle.

It is self-evident that the aforementioned features, and the features to be explained hereinafter, can be applied not only in the combination specified in each case, but also in other combinations or in isolation, without departing from the scope of the present invention.

### BRIEF DESCRIPTION OF THE SEVERAL VIEWS OF THE DRAWING

Exemplary embodiments of the invention are represented in the drawing and are explained in more detail in the following description. In the drawing:

FIG. 1 is a schematic longitudinal representation of an embodiment of a hybrid drive train according to the invention;

FIG. 2 shows a further embodiment of a hybrid drive train according to the invention in a schematic longitudinal representation;

FIG. 3 shows a further embodiment of a hybrid drive train according to the invention in a schematic longitudinal representation;

FIG. 4 shows a further embodiment of a hybrid drive train according to the invention in a schematic longitudinal representation;

FIG. 5 shows a further embodiment of a hybrid drive train according to the invention in a schematic longitudinal representation;

FIG. 6 shows a further embodiment of a hybrid drive train according to the invention in a schematic longitudinal representation; and

FIG. 7 shows a further embodiment of a hybrid drive train according to the invention in a schematic longitudinal representation.

### PREFERRED EMBODIMENTS

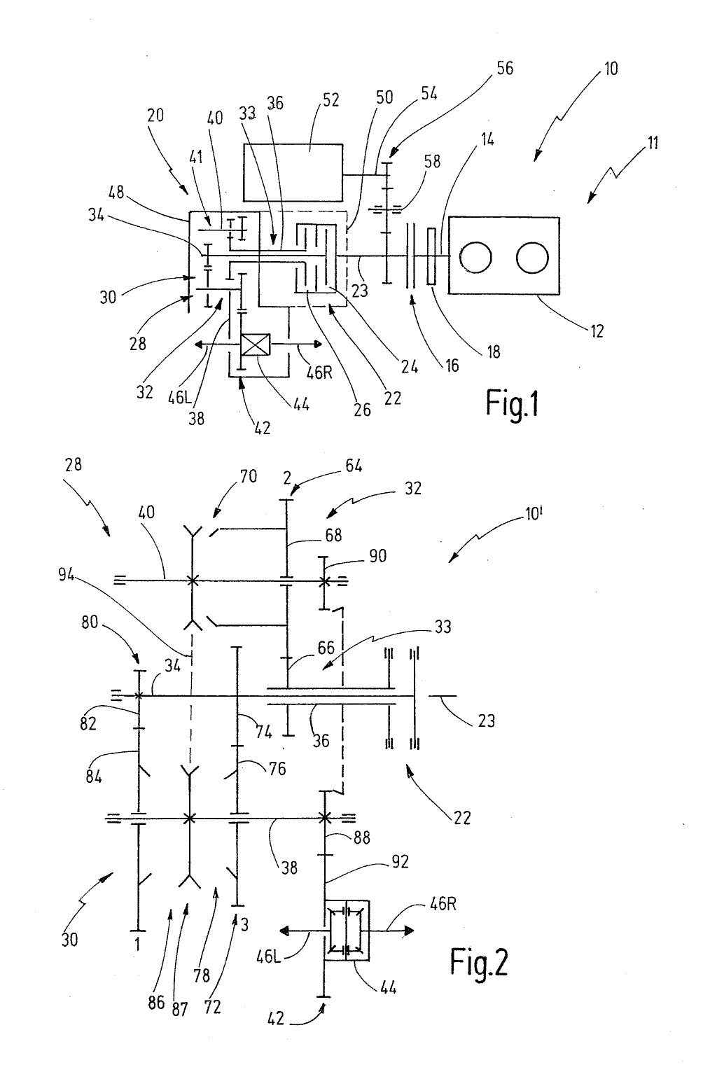

In FIG. 1 a first embodiment of a hybrid drive train is represented schematically in longitudinal section and is denoted as a whole by reference 10. The hybrid drive train 10 is suitable for installation in a motor vehicle 11, especially in a front-transverse layout.

The hybrid drive train 10 includes an internal combustion engine 12 with a crankshaft 14. The crankshaft 14 is connected via a first clutch 16 and optionally a dual mass flywheel 18 to a dual clutch transmission 20.

The dual clutch transmission 20 includes a dual clutch arrangement 22 with an input element 23 which is connected to an output element of the first clutch 16. In addition, the dual clutch arrangement 22 has a second clutch 24 and a third clutch 26.

The dual clutch transmission 20 further includes a spur gear transmission arrangement 28 comprising a first part-transmission 30 and a second part-transmission 32.

The dual clutch arrangement 22 is connected via an input shaft arrangement 33 to the spur gear transmission arrangement 28. More exactly, a first input shaft 34 is, on the one hand, connected to an output element of the second clutch 24 and represents an input shaft for the first part-transmission 30. In a corresponding manner, a second input shaft 36 of the input shaft arrangement 33 is connected to an output element of the third clutch 26 and represents an input shaft for the second part-transmission 32.

The spur gear transmission arrangement 28 further includes a first output shaft 38 which is arranged parallel to the input shaft arrangement 33, and a second output shaft 40 which is aligned parallel to the first output shaft 38 and to the input shaft arrangement 33. The input shaft arrangement 33 and the output shafts 38, 40 are connected to one another via schematically indicated gear set arrangements 41 in order to set gear stages. In addition, the output shafts 38, 40 are connected via a drive gear set 42 to an input element of a differential 44, by means of which motive power is distributed to two driven wheels 46L, 46R.

The dual clutch transmission 20 includes a transmission housing 48, inside which the differential 44 and the drive gear set 42 are preferably also arranged. The dual clutch arrangement 22 is preferably received in a clutch housing 50 which is preferably flange-mounted to the transmission housing 48.

The drive train 10 further includes an electric machine 52 which is configured to provide motive power in a motor mode, or electric power in a generator mode.

The electric machine 52 has a motor shaft 54 which is coupled via a spur gear set 56 to the input element 23 of the dual clutch arrangement 22. The spur gear set 56 may be of one-stage configuration or, as illustrated, two-stage with an intermediate shaft 58.

In the present case, the spur gear transmission arrangement 28 has exactly three forward gear stages or exactly four forward gear stages. The spur gear transmission arrangement 28 may in this case have a reverse gear stage or no reverse gear stage. In the latter case reverse driving operation is implemented solely by means of the electric machine 52.

A first forward gear stage of the spur gear transmission arrangement 28 may have a loose gear which is coupled via a free-wheel to the associated output shaft. In the case of a spur gear transmission arrangement 28 with three forward gear stages, it may further be preferred if only a single gear stage is allocated to one of the part-transmissions, which in this case is implemented using two fixed gears. In both the last-mentioned variants a shift clutch for engaging and disengaging the respective associated gear stage can in each case be saved.

In the following FIGS. 2 to 6, further embodiments of hybrid drive trains, which generally correspond to the hybrid drive train represented in FIG. 1 with respect to structure and operation, are represented. Like elements are therefore denoted by the same reference symbols. In what follows primarily the differences are explained.

In the hybrid drive train 10′ of FIG. 2, the spur gear transmission arrangement 28 includes, adjacently to an input (that is, facing towards the dual clutch arrangement 22) a gear set 64 for the forward gear stage 2. The gear set 64 includes a fixed gear 66 which is fastened to the second input shaft 36 and a loose gear 68 which is mounted rotatably on the second output shaft 40. A shift clutch 70 for the forward gear stage 2 is also arranged on the second output shaft 40.

The spur gear transmission arrangement 28 further includes a gear set 72 for the forward gear stage 3 which, viewed in the axial direction, is arranged on the side of the gear set 64 for the forward gear stage 2 facing away from the dual clutch arrangement 22. The gear set 72 is preferably arranged between the gear set 64 and the shift clutch 70 in the axial direction. The gear set 72 for the forward gear stage 3 includes a fixed gear 74 which is rigidly connected to the first input shaft 34 and a loose gear 76 which is mounted rotatably on the first output shaft 38.

In addition, a shift clutch 78 for the forward gear stage 3 is configured on the first output shaft 38.

The spur gear transmission arrangement 28 further includes a gear set 80 for the forward gear stage 1. The gear set 80 is arranged in the region of an end of the spur gear transmission arrangement 28 opposite the input of the spur gear transmission arrangement 28 and includes a fixed gear 82 which is connected rigidly to the first input shaft 34. The gear set 80 further comprises a loose gear 84 which is mounted rotatably on the first output shaft 38. A shift clutch 86 for the forward gear stage 1 is also arranged on the first output shaft 38. The shift clutch 86 for the forward gear stage 1 forms, together with the shift clutch 78 for the forward gear stage 3, a shift clutch pack 87.

The spur gear transmission arrangement 28 further includes a first output gear 88 which is connected non-rotatably to the first output shaft 38, and a second output gear 90 which is connected non-rotatably to the second output shaft 40. The two output gears 88, 90 mesh with a drive gear 92, which is connected to an input element of the differential 44. The output gears 88, 90 and the drive gear 92 form the drive gear set 42.

The drive gear set 42 is arranged between the gear set 64 for the forward gear stage 2 and the dual clutch arrangement 22, viewed in the axial direction.

The shift clutch 78, or the shift clutch pack 87, and the shift clutch 70 are aligned with one another in the axial direction, or lie substantially in an axial plane which is marked 94 and is arranged between the gear sets 72 and 80 in the axial direction.

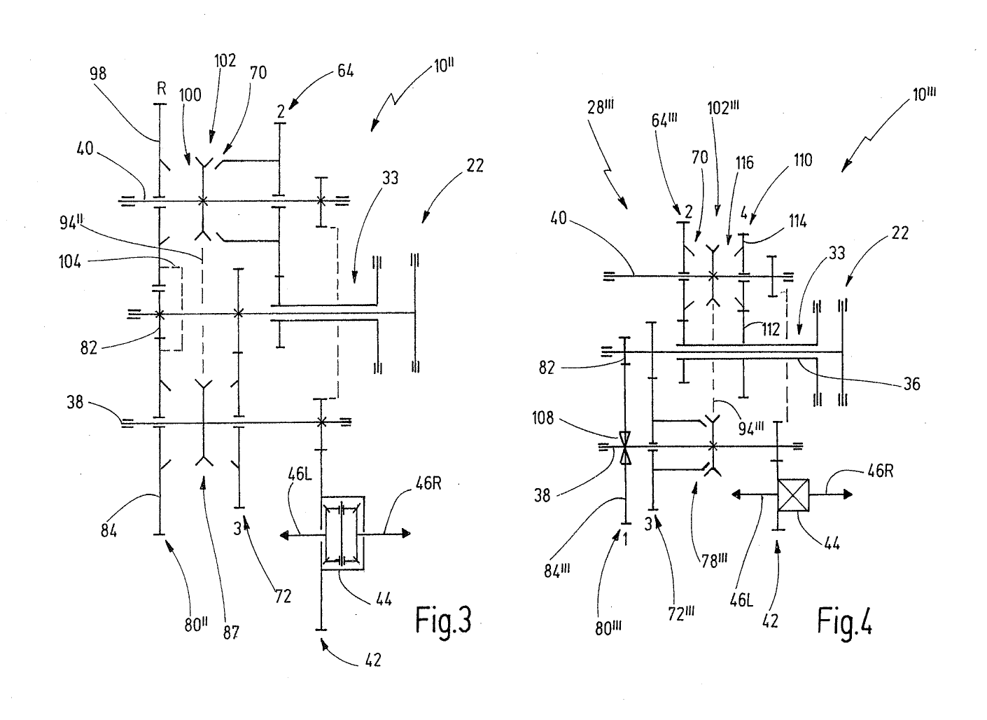

FIG. 3 shows a hybrid drive train 10″ which corresponds generally to the hybrid drive train 10′ of FIG. 2 with regard to structure and operation. Like elements are therefore denoted by the same reference symbols. Primarily the differences are explained in what follows.

The hybrid drive train 10″ comprises, in addition to the components of the hybrid drive train 10′ of FIG. 2, a loose gear 98 for a reverse gear stage R which is mounted rotatably on the second output shaft 40. The loose gear 98 either meshes directly with the loose gear 84 for the forward gear stage 1, or is coupled to the associated input shaft via a rotational-direction reversing gear.

In the present case the hybrid drive train 10″ further includes a shift clutch 100 for the reverse gear stage, the shift clutch 100 forming together with the shift clutch 70 a second shift clutch pack 102, which is aligned axially with the shift clutch pack 87, as indicated at 94″.

The rotational-direction reversal 104 required for the reverse gear stage R is indicated schematically in FIG. 3.

It is preferred in any case if the loose gear 98 for the reverse gear stage R is aligned axially with the gear set 80″, or is a part of this gear set 80″.

FIG. 4 shows a further embodiment of a hybrid drive train 10′″ which corresponds generally to the drive train 10′ of FIG. 2 with regard to structure and operation. Like elements are therefore denoted by the same reference symbols. Primarily the differences are explained in what follows.

In the hybrid drive train 10′″ the loose gear 84′″ of the forward gear stage 1 is coupled via a free-wheel 108 to the associated first output shaft 38, or is mounted on the first output shaft 38 via the free-wheel 108. With this embodiment it is unnecessary to provide an associated shift clutch for the forward gear stage 1, resulting in an axially compact structure. The configuration of the gear set 64′″ with the free-wheel 108 can also be implemented in the hybrid drive trains described hereinbefore and in the hybrid drive trains described hereinafter.

The hybrid drive train 10′″ further includes a gear set 110 for the forward gear stage 4. The gear set 110 includes a fixed gear 112 which is connected non-rotatably to the second input shaft 36, and a loose gear 114 which is mounted rotatably on the second output shaft 40. A shift clutch 116, which is integrated with the shift clutch 70 for the forward gear stage 2 in a shift clutch pack 102′″, is associated with the loose gear 114. The shift clutch pack 102′″ is aligned in the axial direction with the shift clutch 78′″ for the forward gear stage 3, as indicated at 94″.

In the axial direction, the hybrid drive train 10′″ comprises, starting from the transmission input, the following gear sets and components: the drive gear set 42, the gear set 110 for the forward gear stage 4, a plane 94 for the shift clutches 78′″, 70, 116, the gear set 64′″ for the forward gear stage 2, the gear set 72′″ for the forward gear stage 3 and the gear set 80′″ for the forward gear stage 1.

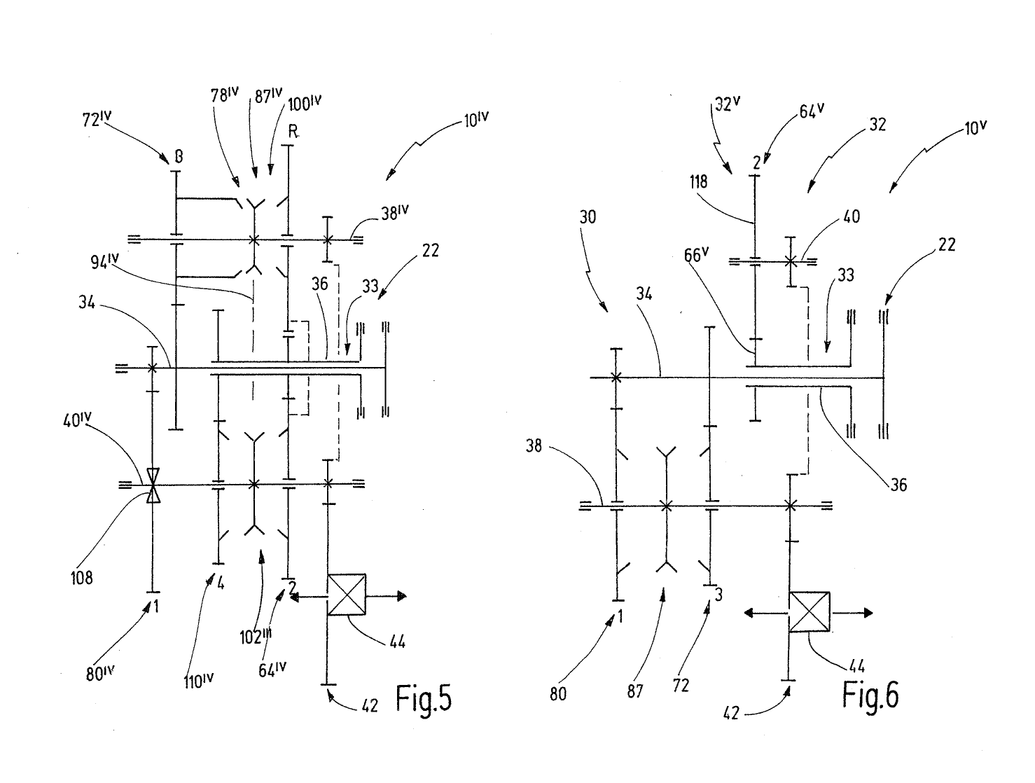

FIG. 5 shows a further embodiment of a hybrid drive train 10IV, which corresponds generally to the drive train 10′ of FIG. 2 with regard to structure and operation. Like elements are therefore denoted by the same reference symbols. In the present case the hybrid drive train 10 IV comprises, starting from the transmission input, the drive gear set 42, a gear set 64 IV, which in the present case is configured to set the forward gear stage 2 and to set the reverse gear stage R, a shift clutch plane 94IV with shift clutch packs 87IV and 102IV, a gear set 110IV for the forward gear stage 4, a gear set 72IV for the forward gear stage 3 and a gear set 80IV for the forward gear stage 1. A loose gear of the gear set 80IV is connected via a free-wheel to the associated output shaft 40IV.

In the hybrid drive train 10IV the reverse gear stage R and the forward gear stage 1 are allocated to different part-transmissions, so that rocking free from stuck situations is simple to effect in terms of control technology.

The gear set 80 IV connects the first input shaft 34 and the second output shaft 40 IV. The gear set 72 IV for the forward gear stage 3 connects the first input shaft 34 to the first output shaft 38 IV. The gear set 110 IV connects the second input shaft 36 to the second output shaft 40 IV. The gear set 64 IV connects the second input shaft 36 to the second output shaft 40 IV with regard to the forward gear stage 2. The gear set 64 IV further includes a loose gear for the reverse gear stage R, which is mounted rotatably on the first output shaft 38 IV.

FIG. 6 shows a further embodiment of a hybrid drive train 10V, which corresponds generally to the drive train 10′ of FIG. 2 with regard to structure and operation. Like elements are therefore denoted by the same reference symbols. Primarily the differences are explained in what follows.

In the hybrid drive train 10V the gear set 64V includes a fixed gear 66V which is connected non-rotatably to the second input shaft 36, and a second fixed gear 118 which is connected non-rotatably to the second output shaft 40. In this case the second part-transmission 32V has only one gear stage, so that the provision of a loose gear and an associated shift clutch for setting this gear stage can be dispensed with.

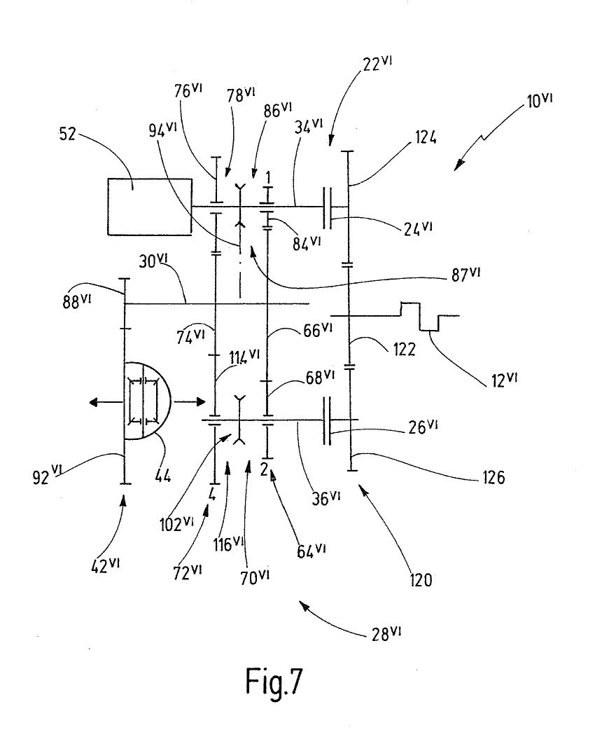

FIG. 7 shows a further embodiment of a hybrid drive train 10VI according to the invention which has a layout deviating somewhat from the embodiments described previously.

Thus, the hybrid drive train 10VI of FIG. 7 includes a power-splitting gear set 120 comprising a central gear 122 together with a first drive gear 124 and a second drive gear 126. The drive gears 124, 126 each mesh with the central gear 122. The central gear 122 is connected non-rotatably to a crankshaft of the internal combustion engine 12VI (optionally via a dual mass flywheel).

The hybrid drive train 10VI further comprises a first input shaft 34VI and a second input shaft 36VI, which are arranged parallel to one another (therefore not coaxially with one another, as in the previous embodiments).

The first input shaft 34VI is connected via a first clutch 24VI of the dual clutch arrangement 22VI to the first drive gear 124. Correspondingly, the second input shaft 36VI is connected via a second clutch 26VI to the second drive gear 126.

The hybrid drive train 10VI further comprises a first gear set 64VI including a fixed gear 66VI which is connected non-rotatably to a single output shaft 38VI. The single output shaft 38VI is connected to an output gear 88VI which meshes with a drive gear 92VI of a differential 44 and forms therewith a drive gear set 42VI.

The gear set 64VI further includes for the forward gear stage 2 a loose gear 68VI which is mounted rotatably on the second input shaft 36VI and is connectable thereto by means of an associated shift clutch 70VI. The gear set 64VI further includes for the forward gear stage 1 a loose gear 84VI which is mounted rotatably on the first input shaft 34VI and with which a shift clutch 86VI is associated. The loose gears 84VI, 68VI each mesh with the fixed gear 66VI, producing a so-called dual use.

The hybrid drive train 10VI also comprises a further gear set 72VI having a fixed gear 74VI rigidly connected to the output shaft 38VI. The gear set 72VI further includes a loose gear 76VI for the forward gear stage 3 mounted rotatably on the first output shaft 34VI, and a loose gear 114VI for the forward gear stage 4 mounted rotatably on the second input shaft 36VI.

The loose gear 76VI is connectable via a shift clutch 78VI to the first input shaft 34VI. The shift clutch 78VI is integrated with the shift clutch 86VI in a shift clutch pack 87VI.

The loose gear 114VI is connectable by means of a shift clutch 116VI to the second input shaft 36VI, the shift clutch 116VI forming with the shift clutch 70VI a shift clutch pack 102VI.

The shift clutch packs 87VI, 102VI lie in an axial plane, or are aligned axially with one another, as indicated at 94VI. Here, the shift clutch packs are located between the gear sets 64VI, 72VI.

The hybrid drive train 10VI further includes an electric machine 52 which is connected to the first input shaft 34VI. A purely electromotive mode can therefore be implemented via the forward gear stages 1, 3. An internal combustion engine mode can be implemented via all the forward gear stages 1, 2, 3, 4.

If the central gear 122 is connected via a coupling device 16 to the internal combustion engine 12VI (not shown), the electric machine 52 can also utilize the forward gear stages 2, 4, the two clutches 24VI, 26VI being closed and the coupling device being opened.

With this embodiment a reverse driving mode is implemented solely by means of the electric machine 52.

What is claimed is:

1. Hybrid drive train for a motor vehicle, comprising
an internal combustion engine;
an electric machine;
a dual clutch transmission having a dual clutch arrangement and a spur gear transmission arrangement with two part-transmissions;
wherein the spur gear transmission arrangement is configured to set exactly three forward gear stages, or is configured to set exactly four forward gear stages, the spur gear transmission arrangement being configured with three parallel shaft arrangements which are connected to one another via gear set arrangements in such a way that motive power is transmitted via at least two of the shaft arrangements, depending on the forward gear stage engaged.

2. Hybrid drive train according to claim 1, wherein the internal combustion engine is connected via a coupling device to an input element of the dual clutch arrangement.

3. Hybrid drive train according to claim 1, wherein at least one shift clutch for engaging and disengaging a respective forward gear stage is arranged in each case on two of the shaft arrangements, the shift clutches being aligned with one another axially.

4. Hybrid drive train according to claim 1, wherein the electric machine is connected to an input element of the dual clutch arrangement, the spur gear transmission arrangement comprising an input shaft arrangement with a first input shaft of the first part-transmission and a second, coaxial input shaft of the second part-transmission, as well as a first output shaft and a second output shaft, the output shafts each being connected to a respective output gear and the output gears meshing with a drive gear of a differential.

5. Hybrid drive train according to claim 4, wherein the internal combustion engine is arranged coaxially with the input shaft arrangement, the electric machine being connected via a spur gear set or via a tooth chain to the input element of the dual clutch arrangement.

6. Hybrid drive train according to claim 4, wherein the output gears and the drive gear of the differential form a drive gear set which is arranged, in an axial direction, between the dual clutch arrangement and gear set arrangements of the forward gear stages.

7. Hybrid drive train according to claim 4, wherein the first input shaft and at least one of the first and the second output shaft are connected to one another via two gear sets which are allocated to a first and a third forward gear stage.

8. Hybrid drive train according to claim 7, wherein the gear set allocated to the first forward gear stage has a loose gear mounted via a free-wheel on the first output shaft.

9. Hybrid drive train according to claim 4, wherein the second input shaft and the second output shaft are connected to one another via at least one gear set which is allocated to a second forward gear stage.

10. Hybrid drive train according to claim 1, wherein the one of the part-transmissions has only one gear stage, which is formed by a gear set comprising two meshing fixed gears.

11. Hybrid drive train according to claim 1, wherein the spur gear transmission arrangement has two parallel input shafts and one output shaft, a first friction clutch of the dual clutch arrangement being arranged coaxially with the first input shaft, a second friction clutch of the dual clutch arrangement being arranged coaxially with the second input shaft and input elements of the friction clutches being connected via a power-splitting gear set to a crankshaft of the internal combustion engine.

12. Hybrid drive train according to claim 11, wherein the two input shafts and the output shaft are connected to one another via at least one gear set comprising a fixed gear connected non-rotatably to the output shaft, a loose gear mounted rotatably on the first input shaft and a loose gear mounted rotatably on the second input shaft.

13. Hybrid drive train according to claim 11, wherein the electric machine is connected to one of the input shafts.

14. Hybrid drive train according to claim 11, wherein the output shaft is connected to an output gear which meshes with a drive gear of a differential.

15. Hybrid drive train for a motor vehicle, comprising
an internal combustion engine;
an electric machine;
a dual clutch transmission having a dual clutch arrangement and a spur gear transmission arrangement with two part-transmissions,
wherein the electric machine is connected to an input element of the dual clutch arrangement, the spur gear transmission arrangement comprising an input shaft arrangement with a first input shaft of the first part-transmission and a second, coaxial input shaft of the second part-transmission, as well as a first output shaft and a second output shaft, the output shafts each being connected to a respective output gear and the output gears meshing with a drive gear of a differential.

16. Hybrid drive train according to claim 15, wherein the one of the part-transmissions has only one gear stage, which is formed by a gear set comprising two meshing fixed gears.

17. Hybrid drive train for a motor vehicle, comprising
an internal combustion engine;
an electric machine;
a dual clutch transmission having a dual clutch arrangement and a spur gear transmission arrangement with two part-transmissions,
wherein the spur gear transmission arrangement has two parallel input shafts and one output shaft, a first friction clutch of the dual clutch arrangement being arranged coaxially with the first input shaft, a second friction clutch of the dual clutch arrangement being arranged coaxially with the second input shaft and input elements of the friction clutches being connected via a power-splitting gear set to a crankshaft of the internal combustion engine.

18. Hybrid drive train according to claim 17, wherein the two input shafts and the output shaft are connected to one another via at least one gear set comprising a fixed gear connected non-rotatably to the output shaft, a loose gear mounted rotatably on the first input shaft and a loose gear mounted rotatably on the second input shaft.

19. Hybrid drive train according to claim 17, wherein the electric machine is connected to one of the input shafts.

20. Hybrid drive train according to claim 17, wherein the output shaft is connected to an output gear which meshes with a drive gear of a differential.
